(19) United States
(12) Patent Application Publication
(10) Pub. No.: US 2024/0299882 A1
(43) Pub. Date: Sep. 12, 2024

(54) FILTERING SYSTEM INCLUDING CATALYST FILTER

(71) Applicants: Samsung Electronics Co., Ltd., Suwon-si (KR); POSTECH Research and Business Development Foundation, Gyeongsangbuk-do (KR)

(72) Inventors: Min Seok Koo, Suwon-si (KR); Jawon Kim, Pohang-si (KR); Jongkyu Kim, Pohang-si (KR); Hyun Chul Lee, Suwon-si (KR); Hyukjae Kwon, Suwon-si (KR); Sangmin Ji, Suwon-si (KR)

(21) Appl. No.: 18/244,235

(22) Filed: Sep. 9, 2023

(30) Foreign Application Priority Data
Mar. 7, 2023 (KR) 10-2023-0030197

(51) Int. Cl. B01D 53/88; B01D 46/00; B01D 53/86; B01J 21/06; B01J 23/30; B01J 35/00; B01J 35/04; G02B 6/26

(52) U.S. Cl. CPC B01D 53/885; B01D 46/0028; B01D 53/8687; B01J 21/063; B01J 23/30; B01J 35/39; B01J 35/56; G02B 6/262; B01D 2255/20707; B01D 2255/20776; B01D 2255/802; B01D 2255/9155; B01D 2257/708; B01D 2257/91; B01D 2259/802; B01D 2259/804

(57) ABSTRACT

A filtering system includes: a catalyst filter including a filter frame including a first surface and a second surface opposite to the first surface, and a photocatalyst layer provided on the second surface of the filter frame; a light source unit configured to irradiate light for activating the photocatalyst layer; and a plurality of waveguides inserted into at least some of a plurality of channels, respectively, to increase light transmission into the at least some of the plurality of channels of the catalyst filter.

### CROSS-REFERENCE TO RELATED APPLICATION

This application claims priority to Korean Patent Application No. 10-2023-0030197, filed on Mar. 7, 2023, and all the benefits accruing therefrom under 35 U.S.C. § 119, the content of which in its entirety is herein incorporated by reference.

### BACKGROUND

### 1. Field

The disclosure relates to a filtering system including a catalyst filter.

### 2. Description of the Related Art

Filters for reducing fine dust or the like are manufactured in the form of melt blown or woven or nonwoven fabrics of glass fibers or plastics and are classified into grades, such as medium, HEPA, and ULPA, according to the performance thereof. In addition, together with fine dust, volatile organic compounds (“VOCs”) are filtered with deodorization filters that adsorb (deodorize) by using carbon such as activated carbon. These filters have been currently selectively applied to air purifiers, heat exchange ventilators, or air conditioning in buildings. Recently, filters capable of removing biomaterials such as viruses and bacteria are needed.

### SUMMARY

Provided is a filtering system including a catalyst filter capable of removing a particulate material, a gaseous material, a biomaterial, or the like.

Provided is a filtering system capable of efficiently activating a photocatalysis of a catalyst filter.

Additional aspects will be set forth in part in the description which follows and, in part, will be apparent from the description, or may be learned by practice of the presented embodiments of the disclosure.

According to an aspect of the disclosure, a filtering system includes: a catalyst filter including a filter frame including a first surface, which includes a first side surface in a thickness direction, and a second surface, which includes a second side surface opposite to the first side surface in the thickness direction and forms a plurality of channels, where the catalyst filter further includes a photocatalyst layer arranged on the second surface of the filter frame configured to be activated by light energy; a light source unit configured to irradiate light for activating the photocatalyst layer; and a plurality of waveguides inserted into at least some of the plurality of channels, respectively, to increase light transmission into the at least some of the plurality of channels.

Each waveguide of the plurality of the waveguides may have an incident surface on which light is incident from the light source unit, have a rod shape, and have a light extraction region formed on at least a portion of a surface of each waveguide to extract light that is input through the incident surface and guided into each waveguide such that a range in which light is transmitted into a corresponding channel of the at least some of the plurality of channels is expanded.

The light extraction region of each waveguide may be formed by texturing the surface of each waveguide by vapor of an etching solution.

The light extraction region of each waveguide may be formed by texturing each waveguide a plurality of times by vapor of the etching solution while reducing a length of each waveguide dipped into the etching solution.

Each waveguide may be a quartz rod, and the etching solution may be a buffered oxide etchant (“BOE”) solution.

The filter frame may include a catalyst material configured to be activated by energy other than light to remove a gaseous material, or may include a photocatalytic material configured to be activated by light energy.

The photocatalyst layer may include a metal compound having semiconductor characteristics by light, and the metal compound may include at least one of titanium dioxide (TiO₂) and tungsten trioxide (WO₃).

The light source unit may include a plurality of first light sources corresponding to the plurality of channels on a one-to-one basis, and each waveguide of the plurality of the waveguides may receive light incident from a corresponding first light source of the plurality of first light sources.

The filter frame may include: a plurality of first grooves extending in the thickness direction, and including inflow sides opened and outflow sides blocked, and a plurality of second grooves extending in the thickness direction, and including outflow sides opened and inflow sides blocked, where the plurality of first grooves and the plurality of second grooves may be alternately and two-dimensionally arranged, and the second grooves may form the channels.

Each waveguide may be arranged to be spaced apart from the inflow side of a corresponding second groove of the plurality of second grooves.

The filter frame may include a first portion configured to block the outflow sides of the first grooves, a second portion configured to block the inflow sides of the second grooves, and a third portion configured to form a boundary between the first grooves and the second grooves, and the photocatalyst layer may be provided on the second surface of at least one of the second portion and the third portion of the filter frame.

The photocatalyst layer may be further provided on the second surface of the first portion of the filter frame, and the light source unit may further include a plurality of second light sources configured to irradiate light to at least some of regions of the second surface between the plurality of channels.

The first light source and the second light source may include light emitting diodes (“LEDs”).

The first light source may include an LED.

According to another aspect of the disclosure, a filtering system includes: a catalyst filter including a filter frame including a first surface, which includes a first side surface in a thickness direction, and a second surface, which includes a second side surface opposite to the first side surface in the thickness direction and forms a plurality of channels, where the catalyst filter further includes a photocatalyst layer arranged on the second surface of the filter frame and configured to be activated by light energy; a light source unit configured to irradiate light for activating the photocatalyst layer; and a plurality of waveguides inserted into at least some of the plurality of channels, respectively, to increase light transmission into the at least some of the plurality of channels. The filter frame includes a plurality of first grooves extending in the thickness direction, and including inflow sides opened and outflow sides blocked, and a plurality of second grooves extending in the thickness direction, and including outflow sides opened and inflow sides blocked, where the plurality of first grooves and the plurality of second grooves are alternately and two-dimensionally arranged, the second grooves form the channels, and each waveguide of the plurality of waveguides has an incident surface on which light is incident from the light source unit, has a rod shape, and has a light extraction region formed on at least a portion of a surface of each waveguide to extract light that is input through the incident surface and guided into each waveguide such that a range in which light is transmitted into a corresponding channel of the at least some of the plurality of channels is expanded.

The filter frame may include a first portion configured to block the outflow sides of the first grooves, a second portion configured to block the inflow sides of the second grooves, and a third portion configured to form a boundary between the first grooves and the second grooves, and the photocatalyst layer may be provided on the second surface of at least one of the second portion and the third portion of the filter frame.

The photocatalyst layer may be further provided on the second surface of the first portion of the filter frame.

The photocatalyst layer may include a metal compound having semiconductor characteristics by light, and the metal compound may include at least one of TiO₂ and WO₃.

According to another aspect of the disclosure, a method of forming a light extraction region of a waveguide includes forming a light extraction region on a surface of a waveguide by dipping a partial length of the waveguide having an incident surface and having a rod shape into an etching solution and texturing the surface of the waveguide by vapor of the etching solution; and repeating a texturing process a plurality of times by the vapor of the etching solution while reducing by changing the length of the waveguide dipped into the etching solution.

The waveguide may be a quartz rod, and the etching solution may be a BOE solution.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an example of a catalyst filter applied to a filtering system, according to an embodiment;

FIG. 2 is a cross-sectional view of the catalyst filter illustrated in FIG. 1;

FIG. 3 illustrates a schematic diagram of an oxidation/reduction reaction of a photocatalyst;

FIG. 4 is a view schematically illustrating a filtering system including a catalyst filter, according to an embodiment;

FIG. 5 is a perspective view illustrating a light source unit of FIG. 4;

FIG. 6 is a view schematically illustrating a filtering system including a catalyst filter, according to an embodiment;

FIG. 7 is a perspective view illustrating a light source unit of FIG. 6;

FIG. 8 is a view schematically illustrating a filtering system including a catalyst filter, according to an embodiment;

FIG. 9 schematically illustrates a layout of a filtering system according to various embodiments;

FIG. 10 illustrates an arrangement relationship between a second groove of a filter frame and a waveguide in a filtering system, according to an embodiment;

FIG. 11 illustrates an example of an operation in which light transmission into a channel increases in a filtering system, according to an embodiment;

FIG. 12A illustrates an operation of irradiating light to a channel in a filtering system of a comparative example;

FIG. 12B is an image illustrating light transmission inside a channel in a filtering system of a comparative example;

FIG. 13 is a front view of a catalyst filter according to an embodiment;

FIG. 14 is a cross-sectional view of the catalyst filter illustrated in FIG. 13;

FIG. 15 is a cross-sectional view of a catalyst filter according to an embodiment;

FIGS. 16 and 17 illustrate a process of forming a light extraction region by texturing a surface of a waveguide;

FIG. 18 illustrates a change in light extraction efficiency according to a condition of forming a light extraction region on a surface of a waveguide (a quartz rod);

FIGS. 19 and 20 illustrate results of measuring a photocurrent at a side surface and a lower end of a waveguide according to an etching time; and

FIG. 21 illustrates the formaldehyde (“HCHO”) removal efficiency of a filtering system, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings. Like reference numerals in the drawings denote like elements, and in the drawings, the sizes of elements may be exaggerated for clarity and convenience of description. Meanwhile, the embodiments described below are merely examples, and various modifications may be made from these embodiments.

Hereinafter, what is described as “above” or “on” may include not only those directly above, below, left, and right by contact, but also those above, below, left, and right by non-contact. The singular forms are intended to include the plural forms as well, unless the context clearly indicates otherwise. In addition, when an element “comprises” or “includes” another element, this means that it may further include other elements, rather than excluding the other elements, unless specifically stated otherwise.

The use of the term “the” and similar indicative terms may correspond to both singular and plural. Unless the order of steps constituting a method is explicitly stated or stated to the contrary, these steps may be performed in an appropriate order, and are not necessarily limited to the described order.

In addition, the terms “ . . . unit”, “module”, etc. described herein refer to units that process at least one function or operation, and may be implemented as hardware or software or as a combination of hardware and software.

Connections of lines or connection members between components shown in the drawings are examples of functional connections and/or physical or circuit connections, and may be represented as alternative or additional various functional connections, physical connections, or circuit connections in actual devices.

The use of all examples or example terms is simply for describing the technical spirit in detail, and the scope is not limited due to these examples or example terms unless limited by claims.

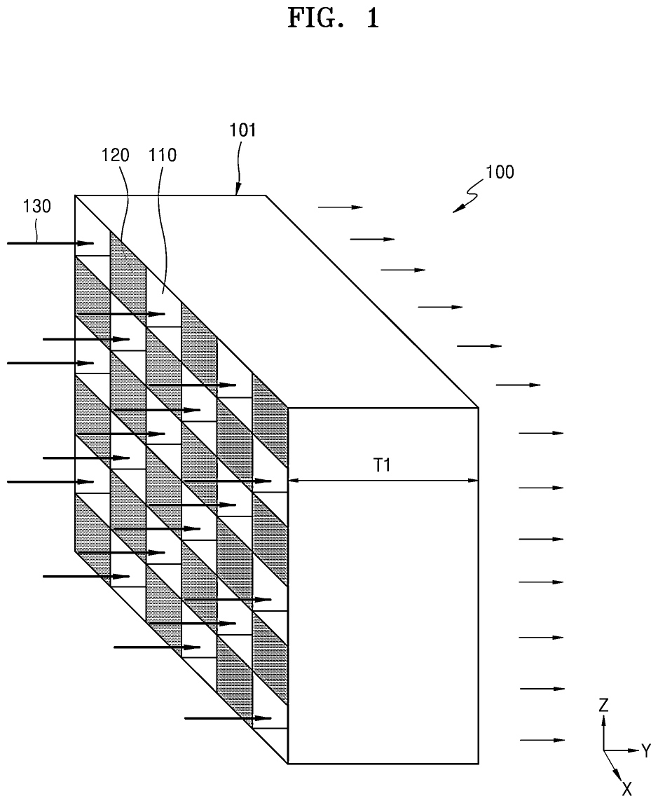

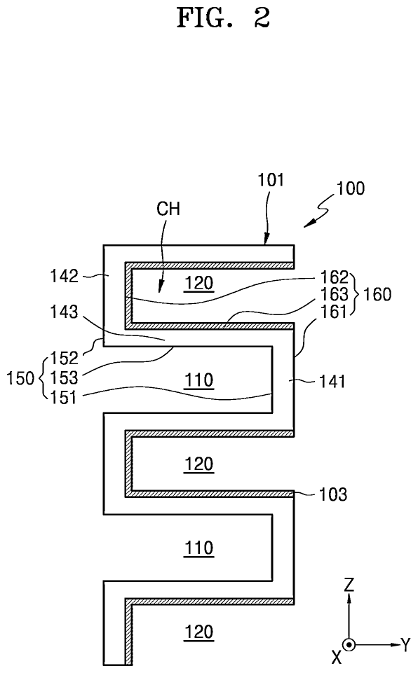

FIG. 1 is a perspective view illustrating an example of a catalyst filter 100 applied to a filtering system, according to an embodiment. FIG. 2 is a cross-sectional view of the catalyst filter 100 illustrated in FIG. 1.

Referring to FIGS. 1 and 2, the catalyst filter 100 may include a filter frame 101 and a photocatalyst layer 103. The catalyst filter 100 may be, for example, a ceramic catalyst filter.

The filter frame 101 includes an inflow surface (a first surface 150) on a first side (i.e., inflow side formed by the first side surfaces 152 and the inlets of the first grooves 110) through which a gas including a material to be purified, for example, a material 130, is introduced and a discharge surface (a second surface 160) on a second side (i.e., outflow side formed by the second side surfaces 161 and the outlets of the second grooves 120) through which the gas is discharged. A plurality of channels CH are formed on the discharge surface, i.e., the second surface 160. The material 130 may include at least two types of materials to be filtered or removed. For example, the material 130 may include a particulate material such as fine dust, a biomaterial such as virus, germ, and bacteria, and/or a gaseous material such as a volatile organic compound (VOC). The filter frame 101 may have a structure capable of filtering out a particulate material and/or a biomaterial. For example, the filter frame 101 may have a porous structure capable of filtering out a particulate material. The particulate material may be, for example, particles having a particle diameter less than or equal to 10 micrometers (μm), i.e., fine particles having a particle diameter less than or equal to PM10. In an example, fine particles may include, for example, fine dust or ultrafine dust having a smaller particle diameter than fine dust, but are not limited thereto.

The filter frame 101 may have a thickness T1. The first surface 150 and the second surface 160 are surfaces facing each other in a thickness direction, for example, in a Y direction. The thickness direction Y is a flow direction of the material 130. The filter frame 101 may have a wall-flow structure. For example, the filter frame 101 may include a plurality of first grooves 110 and a plurality of second grooves 120. The plurality of first grooves 110 and the plurality of second grooves 120 may be alternately and two-dimensionally arranged in a direction orthogonal to the thickness direction, like a checkered pattern in view of the thickness direction. The second groove 120 may form a channel CH.

The first groove 110 extends in the thickness direction Y, and has a shape in which the first side, i.e., a side of the first surface 150 (the inflow surface, the front side), is opened and the second side, i.e., a side of the second surface 160 (the discharge surface, the real side), is blocked. The second groove 120 extends in the thickness direction Y, and has a shape in which the second side (e.g., the real side) is opened and the first side (e.g., the front side) is blocked. The material 130 may mainly flow into the filter frame 101 through the plurality of first grooves 110, and the gas passing through the filter frame 101 may be mainly discharged through the second groove 120. The gas discharged through the second groove 120 may be a relatively clean or harmless gas obtained by filtering a harmful material or impurities from the material 130 flowing in through the first groove 110, or may include the relatively clean or harmless gas and air. A portion of the material 130 may also flow in through a portion between the plurality of first grooves 110, and the gas passing through the filter frame 101 may be discharged through the second groove 120. A portion of the material 130 may also flow in through bottom surface portions of the plurality of first grooves 110, and the gas passing through the filter frame 101 may be discharged through portions between the plurality of second grooves 120.

The plurality of first grooves 110 and the plurality of second grooves 120 may be regularly or irregularly arranged. For example, the plurality of first grooves 110 and the plurality of second grooves 120 may be alternately and two-dimensionally arranged in directions orthogonal to the thickness direction Y, e.g., in X and Z directions. The filter frame 101 may have a shape in which the plurality of first grooves 110 and the plurality of second grooves 120 may be defined. For example, the filter frame 101 may include a first portion 141 for blocking the second side of the first groove 110, a second portion 142 for blocking the first side of the second groove 120, and a third portion 143 for forming a boundary between the first groove 110 and the second groove 120. The first portion 141 and the second portion 142 may be spaced apart from each other in the thickness direction Y, and a plurality of first portions 141 and a plurality of second portions 142 may be arranged in the Z direction. The third portion 143 may extend from an edge of the first portion 141 in the Y direction and may be connected to the second portion 142. The first portion 141 and the second portion 142 may be connected to each other in a zigzag shape in a view of in the Z direction or the X direction by a plurality of third portions 143. A thickness of each of the first portion 141 and the second portion 142 may be the same as or different from a thickness of the third portion 143. First side surfaces 151, 152, and 153 of the first portion 141, the second portion 142, and the third portion 143 (i.e., the first side surface 151 of the first portion 141, the first side surface 152 of the second portion 142, and the first side surface 153 of the third portion 143 together) become the first surface 150, and second side surfaces 161, 162, and 163 of the first portion 141, the second portion 142, and the third portion 143 (i.e., the second side surface 161 of the first portion 141, the second side surface 162 of the second portion 142, and the second side surface 163 of the third portion 143 together) become the second surface 160. Accordingly, the filter frame 101 having the wall-flow structure in which areas of the first surface 150 and the second surface 160 are expanded may be implemented.

The filter frame 101 may be a single-body structure in which the first portion 141, the second portion 142, and the third portion 143 are connected as one. The first portion 141 and the second portion 142 may be integrally formed with the third portion 143 to form the single-body structure. As another example, the filter frame 101 may have a structure in which the first portion 141 and the second portion 142 are inserted in a zigzag shape with respect to an arrangement of the third portion 143 having a length corresponding to the thickness T1. As another example, the filter frame 101 may have a structure in which the first portion 141 and the second portion 142 arranged in a zigzag shape are connected to the third portion 143. FIG. 2 and the following drawings illustrate that the first portion 141 and the second portion 142 are integrally formed with the third portion 143 to form the single-body structure, but the disclosure is not limited thereto, and various modifications may be made.

Meanwhile, the first groove 110 and the second groove 120 may have the same size. For example, widths of the first groove 110 in the X direction and the Z direction may be the same as or different from widths of the second groove 120 in the X direction and the Z direction respectively. A length of the first groove 110 in the thickness direction Y may be the same as or different from a length of the second groove 120 in the thickness direction Y. Sizes of the plurality of first grooves 110 may be the same as or different from each other. Sizes of the plurality of second grooves 120 may be the same as or different from each other.

The filter frame 101 may be formed of a porous material (e.g., a porous ceramic material) capable of filtering out a particulate material. The porous ceramic material may be, for example, cordierite, SiC, Al₂TiO₅, or the like. Permeabilities of the first portion 141 and the second portion 142 may each be lower than a permeability of the third portion 143. Here, the material 130 may flow into the filter frame 101 through the first groove 110, and the gas may mainly pass through the third portion 143 and be discharged through the second groove 120. In another embodiment, the first portion 141 and the second portion 142 may also be non-permeability. In still another embodiment, the permeabilities of the first portion 141 and the second portion 142 may each be the same as the permeability of the third portion 143. Even in this case, an area of the third portion 143 may be greater than an area of each of the first portion 141 and the second portion 142, and thus, the material 130 may mainly flow into the filter frame 101 through the first groove 110, and the gas may be discharged through the second groove 120 by mainly passing through the third portion 143.

As described above, the material 130 may mainly flow into the filter frame 101 through the first groove 110, a particulate material, a biomaterial, or the like in the material 130 may be filtered out by the third portion 143, and the gas passing through the third portion 130 may be discharged through the second groove 120.

The photocatalyst layer 103 may be provided on at least a portion of the second surface 160 of the filter frame 101 to remove a harmful gas from the gaseous material passing through the filter frame 101 by a photocatalytic action. The photocatalyst layer 103 may be formed on at least a portion of the second surface 160 of the filter frame 101 by coating, chemical vapor deposition, physical vapor deposition, or the like. As described above, the material 130 may mainly flow into the filter frame 101 through the first groove 110, the particulate material, the biomaterial, or the like in the material 130 may be filtered out by the third portion 143, and the gas passing through the third portion 143 may be discharged through the second groove 120. Therefore, the photocatalyst layer 103 may be formed on the second side surface 163 of at least the third portion 143 of the second surface 160. The gas may also flow into the second groove 120 by passing through the second portion 142, and thus, the photocatalyst layer 103 may also be formed on the second side surface 162 of the second portion 142 forming a first wall of the second groove 120, as well as on the second side surface 163 of the third portion 143. In other words, the photocatalyst layer 103 may be further formed on the second side surface 162 of the second portion 142. In addition, the photocatalyst layer 103 may be further formed on the second side surface 161 of the first portion 141. As described above, the photocatalyst layer 103 may be formed on at least some of the second side surfaces 161, 162, and 163 of the first portion 141, the second portion 142, and the third portion 143. FIG. 2 illustrates an example in which the photocatalyst layer 103 is formed on the second side surfaces 162 and 163 of the second portion 142 and the third portion 143.

The photocatalyst layer 103 may include a metal compound capable of producing a photocatalytic reaction by receiving light energy. The metal compound may be, for example, a photocatalyst having semiconductor characteristics by light, such as titanium dioxide (TiO₂) or tungsten trioxide (WO₃). The light energy may be ultraviolet energy or visible light energy.

For example, the photocatalyst layer 103 may include a photocatalyst having a structure of second metal oxide, e.g., TiO₂, having a surface on which first metal oxide, e.g., Cu₂O, is disposed.

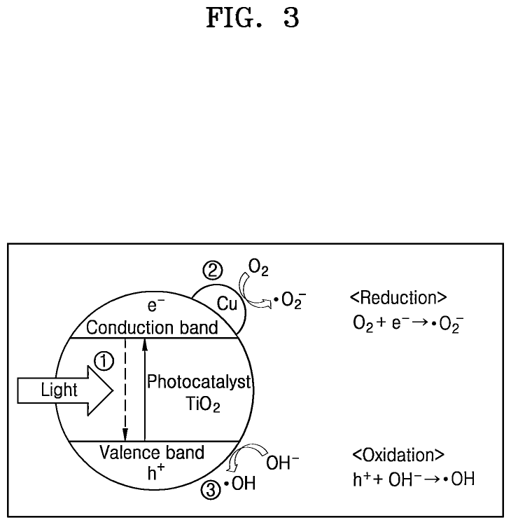

FIG. 3 illustrates a schematic diagram of an oxidation/reduction reaction of a photocatalyst. As illustrated in FIG. 3, when light (ultraviolet) energy, which is greater than or equal to band gap energy, is irradiated on a surface of second metal oxide (e.g., TiO₂), a pair of electron e− and hole h+ is generated due to transition of an electron from a valence band to a conduction band. A hole generated in the valence band contributes to oxidation, and reacts with a water molecule adsorbed on a surface thereof to generate hydroxyl radical (·OH), or oxidizes organic materials, e.g., VOCs, through a direct reaction. An electron generated in the conduction band produces a reduction reaction of an oxygen molecule to form a superoxide ion·O₂⁻, and generates hydroxyl radical through several stages of additional reaction. The VOCs may be decomposed into carbon dioxide and water by the hydroxyl radicals generated by the hole and the electron.

First metal oxide (e.g., Cu₂O) of the photocatalyst has a relatively narrower distance between the valence band and the conductive band than the second metal oxide (e.g., TiO₂). Accordingly, the first metal oxide has a characteristic of oxidizing and decomposing the VOCs even in a visible light region. The first metal oxide may be disposed (or supported) on the surface of the second metal oxide to absorb many electrons e− generated on the surface of the second metal oxide. As a result, the number of holes h+ of the first metal oxide may increase and an oxidation reaction may increase, and thus, the oxidation of the VOCs may be promoted and decomposition and removal efficiency and a removal reaction rate of the VOCs may increase. In addition, the transfer of superior charges at an interface between the second metal oxide and the first metal oxide may further increase an energy conversion rate by moving more many electrons in a reduction reaction from the VOCs to carbon dioxide. Therefore, the photocatalyst having the structure of the second metal oxide on which the first metal oxide is disposed may increase absorbance in ultraviolet and visible light wavelength regions.

Referring back to FIGS. 1 and 2, a gas component included in the material 130 passes through the filter frame 101 and contacts the photocatalyst layer 103. The gas component may be decomposed by producing a photocatalytic oxidation reaction while passing through the photocatalyst layer 103. The gas component may be a VOC or another harmful gas. The VOC may be, for example, formaldehyde, acetaldehyde, ammonia, toluene, acetic acid, or the like. Bio-particles passing through the filter frame 101 may be additionally removed from the photocatalyst layer 103 by a photocatalytic action.

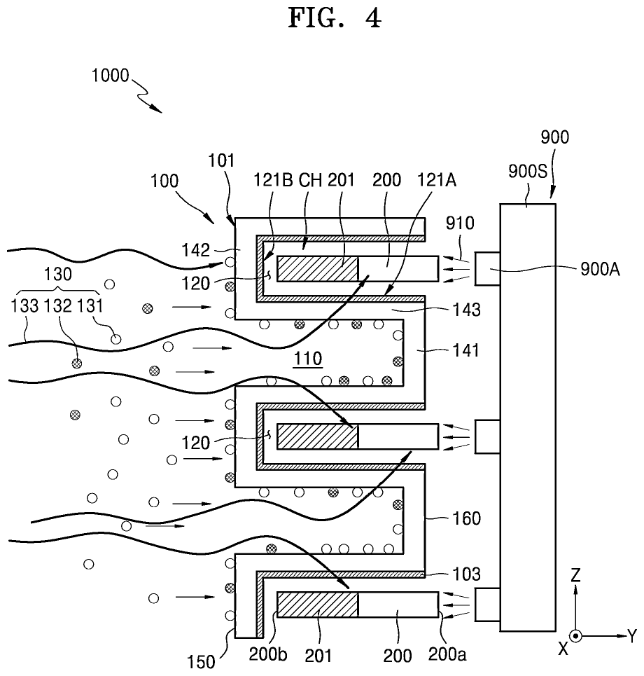

FIG. 4 schematically illustrates a filtering system 1000 including a catalyst filter, according to an embodiment, and illustrates an example in which the catalyst filter 100 illustrated in FIGS. 1 and 2 is applied.

Referring to FIG. 4, the filtering system 1000 includes a catalyst filter 100, a light source unit 900, and a plurality of waveguides 200. As described with reference to FIGS. 1 and 2, the catalyst filter 100 may include a filter frame 101 and a photocatalyst layer 103.

The light source unit 900 may be provided to irradiate light for activating the photocatalyst layer 103 on a second surface 160 of the catalyst filter 100, e.g., ultraviolet light or light in ultraviolet to visible band. The light source unit 900 may include a substrate 900S and a plurality of first light sources 900A forming an array on the substrate 900S. Each of the plurality of first light sources 900A may be provided to irradiate ultraviolet light or light in ultraviolet to visible band. The plurality of first light sources 900A may be, for example, arranged to correspond, on a one-to-one basis, to a plurality of channels CH (formed on the second surface 160 of the filter frame 101). Here, the channel CH may correspond to a second groove 120 of the filter frame 101. Therefore, the plurality of first light sources 900A may be arranged to correspond, on a one-to-one basis, second grooves 120 of the filter frame 101.

The plurality of waveguides 200 may be inserted into a plurality of channels formed on the second surface 160 of the filter frame 101 to efficiently transmit light into the channels of the catalyst filter 100. In other words, the plurality of waveguides 200 may be respectively inserted into the second grooves 120 of the filter frame 101 corresponding to the first light sources 900A. Light 910 generated from the first light source 900A may be transmitted to a deep location inside the second groove 120 through the waveguide 200.

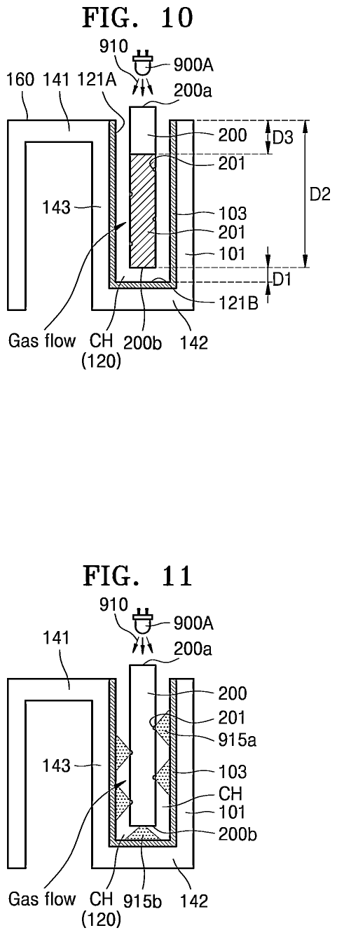

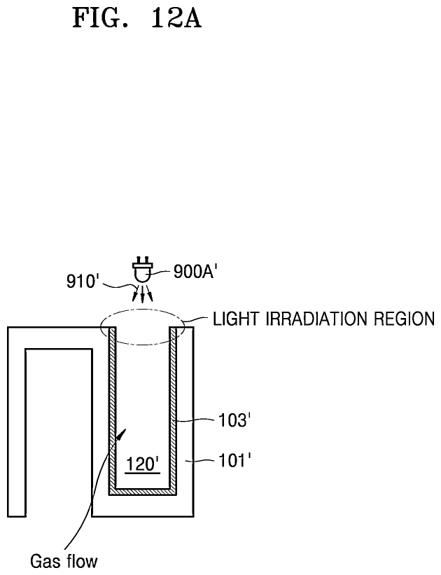

A light extraction region 201 may be formed on at least a portion of a surface of the waveguide 200 (an outer side of a waveguide surface), and may be provided to expand a range (e.g., region) in which light is transmitted inside the channel. The light extraction region 201 may extract light that is input through an incident surface 200a and guided into the waveguide 200, and enable the light to be irradiated, inside the second groove 120, onto the photocatalyst layer 103 formed on a third portion 143 of the filter frame 101. The range in which light is transmitted into the channel may be further expanded by the light extraction region 201. FIG. 4 illustrates that the light extraction region 201 is formed in a partial region of the surface of the waveguide 200, but the disclosure is not limited thereto. A detailed description of the locations, number, range, and the like of the light extraction regions 201 is given below with reference to FIGS. 10 and 11.

As described above, by effectively transmitting light from the first light source 900A into the corresponding channel by using the plurality of waveguides 200, for example, light may be irradiated over a wide range of the photocatalyst layer 103 formed on second side surfaces 162 and 163 of a second portion 142 and the third portion 143 of the filter frame 101.

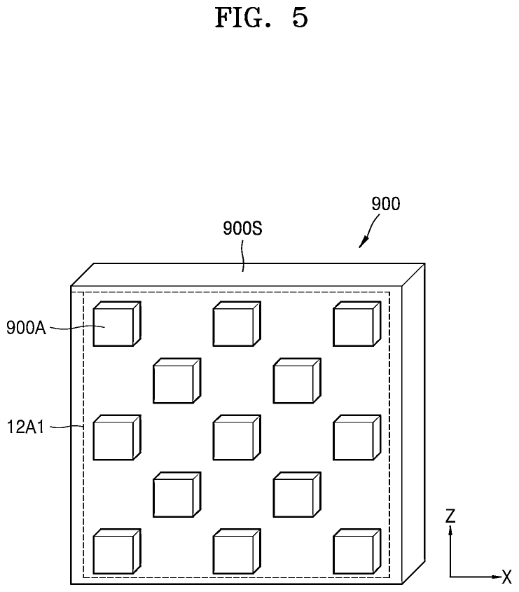

The first light sources 900A of the light source unit 900 may correspond, on a one-to-one basis, to the second grooves 120 that are channels, or may correspond to some of the second grooves 120. For example, as illustrated in FIG. 5, the first light sources 900A may be arranged on the substrate 900S to correspond to an arrangement of the second grooves 120. As illustrated in FIG. 5, a plurality of first light sources 900A may be disposed on one surface of a substrate 900S to form a first light source array 12A1. For example, a distance between centers of neighboring first light sources 900A may be the same as a distance between centers of neighboring second grooves 120. The number of the plurality of first light sources 900A may be the same as or different from the number of second grooves 120 of the catalyst filter 100. For example, the number of the plurality of first light sources 900A may be the same as the number of second grooves 120 on an air discharge side of the catalyst filter 100, i.e., the number of channels. Accordingly, the plurality of first light sources 900A may correspond, on a one-to-one basis, to channels formed on the second surface 160 of the catalyst filter 100. The first light source 900A may include only one light source. As another example, the first light source 900A may also include a plurality of light sources. A light source included in the first light source 900A may be a light emitting diode (LED), but is not limited to the LED, and any light source, which emits light energy capable of activating the photocatalyst layer 103 inside the second groove 120, may be used as the first light source 900A.

Meanwhile, a radiation angle of the light 910 emitted from the first light source 900A may be limited, for example, by considering a size (e.g., a width and depth) of the second groove 120. The radiation angle of the first light source 900A may be limited such that even some of the light 910 may reach a bottom 121B of the second groove 120 through the waveguide 200 inserted into the second groove 120. The limitation on the radiation angle of the first light source 900A may be determined in a process of manufacturing the first light source 900A by considering an arrangement distance between the waveguide 200 and the first light source 900A, a distance between an end surface 200b of an end portion of the waveguide 200 and the bottom 121B of the second groove 120, light extraction efficiency of the light extraction region 201 on the surface of the waveguide 200, and the like.

As illustrated in FIGS. 10 and 11, the light 910, which is emitted from the first light source 900A, may be guided by the waveguide 200 inserted into a channel CH and propagate into the channel CH, and some light may reach the end of the channel CH. In FIGS. 10 and 11, the channel CH corresponds to the second groove 120, and the end of the channel CH corresponds to the bottom 121B of the second groove 120.

As a result, the light 910 emitted from each of the first light sources 910A may be irradiated over a wide range inside the corresponding second groove 120. The result shows that light energy may be irradiated to the photocatalyst layer 103 over the wide range inside the second groove 120, i.e., over a side 121A and the bottom 121B of the second groove 120, to produce a photocatalytic reaction in a wide range. As described above, by inserting the waveguide 200 into the channel, a photocatalytic reaction may occur over the side 121A and the bottom 121B of the second groove 120, and thus, removal efficiency of a gas component may increase.

Referring back to FIG. 4, a material 130 may include a particulate material 131, a biomaterial 132, and a gaseous material 133. The particulate material 131 may be, for example, particles having a particle diameter less than or equal to 10 μm, i.e., fine particles having a particle diameter less than or equal to PM10. The fine particles may include, for example, fine dust. The biomaterial 132 may include, for example, virus, bacteria, or the like. The gaseous material 133 may include, for example, a VOC described above.

The particulate material 131 or the biomaterial 132 may not pass through the filter frame 101, and may be accumulated on a first surface 150 or removed. Accordingly, the particulate material 131 such as fine dust or the biomaterial 132 may be filtered out from the material 130. A layer for removing the biomaterial 132 may be further provided on the first surface 150 of the filter frame 101, and the biomaterial 132 may be removed by the layer. The gaseous material 133 passing through the filter frame 101 may be decomposed by a photocatalytic action by light energy irradiated onto the photocatalyst layer 103 provided on the second surface 160. For example, when the gaseous material 133 includes formaldehyde (HCHO), the formaldehyde may produce a catalytic reaction with oxygen present in the second groove 120 while passing through the photocatalyst layer 103 and thus may be decomposed into water and carbon dioxide (CO₂). Accordingly, the VOC or another harmful gas may be removed. When the biomaterial 132 passing through the filter frame 101 is present, the biomaterial 132 may be additionally removed by a photocatalytic action of the photocatalyst layer 103. In addition, the biomaterial 132 may also be additionally removed by a sterilization action of ultraviolet rays irradiated by the light source unit 900. To this end, the plurality of first light sources 900A of the light source unit 900 may be provided to irradiate, for example, short-wavelength ultraviolet rays having strong sterilization power. As illustrated in FIGS. 1 and 2, when the filter frame 101, which includes a plurality of first grooves 110 and a plurality of second grooves 120 alternately and two-dimensionally arranged, is used, areas of the first surface 150 and the second surface 160 may be expanded, and the photocatalyst layer 103 may be formed in a wide area, and thus, performance of the catalyst filter 100 removing a particulate material, a biomaterial, and a gaseous material may be improved.

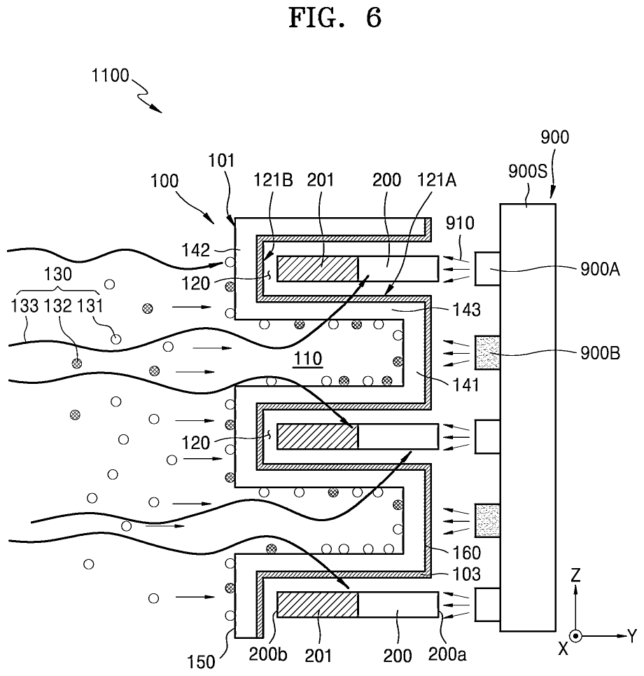

Meanwhile, as illustrated in FIG. 6, the photocatalyst layer 103 may also be formed on a second side surface of a first portion 141 of the filter frame 101. Here, the light source unit 900 may be provided to irradiate light to at least some of regions between a plurality of channels of the second surface 160 corresponding to the first portion 141. FIG. 6 schematically illustrates a filtering system 1100 including a catalyst filter, according to an embodiment, and compared to FIG. 4, a photocatalyst layer 103 is further provided on a second surface 160 of a first portion 141 of a filter frame 101, i.e., a second side surface (e.g., the second side surface 161 of FIG. 2), and a light source unit 900 further includes a plurality of second light sources 900B. The plurality of second light sources 900B are arranged to irradiate light to a region between channels, i.e., a portion of the photocatalyst layer 103 on the second side surface 161. Like a plurality of first light sources 900A, each of the plurality of second light sources 900B may be provided to irradiate ultraviolet light or light in ultraviolet to visible band.

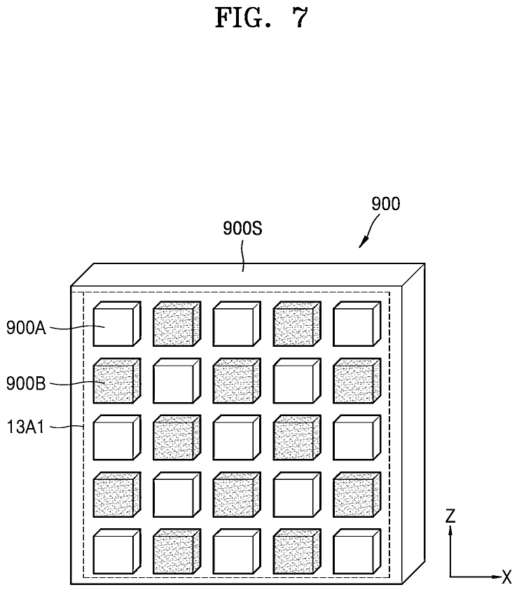

As shown in FIG. 7, the plurality of first light sources 900A and the plurality of second light sources 900B may be arranged on a substrate 900S to form a second light source array 13A1. Here, the alignment form of the plurality of first light sources 900A may be the same as the arrangement form of the first light source array 12A1 of FIG. 5. The plurality of second light sources 900B may correspond, on a one-to-one basis, to first grooves 110 located between channels, or may correspond to at least some locations. The number of the second light sources 900B may be the same as or different from the number of first grooves 110 of a catalyst filter 100. As illustrated in FIG. 7, the second light sources 900B may be disposed on the substrate 900S to correspond to the arrangement of the first grooves 110. For example, the second light source 900B may be located between the first light sources 900A, and the arrangement form of the plurality of second light sources 900B may be the same as the arrangement form of the plurality of first light sources 900A. In other words, when the plurality of first light sources 900A or the plurality of second light sources 900B are moved in an X-axis or a Z-axis direction, the plurality of first light sources 900A and the plurality of second light sources 900B may accurately overlap each other. Like the first light source 900A described above, the second light source 900B may include only one light source or may include a plurality of light sources. The light source included in the second light source 900B may be an LED, but is not limited to the LED, and any light source, which emits light energy capable of activating the photocatalyst layer 103 formed on the second side surface 161 of the first portion 141, may be used as the second light source 900B.

As illustrated in FIGS. 6 and 7, when the photocatalyst layer 130 is provided even on a second surface 160 between the second grooves 120 of the catalyst filter 100 and a plurality of second light sources 900B are further included to correspond thereto, a gaseous material 133 passing through the filter frame 101 may be decomposed even on the second surface 160 of the first portion 141 by a photocatalytic action of the photocatalyst layer 103, and thus, a removal rate of the gaseous material 133 may increase.

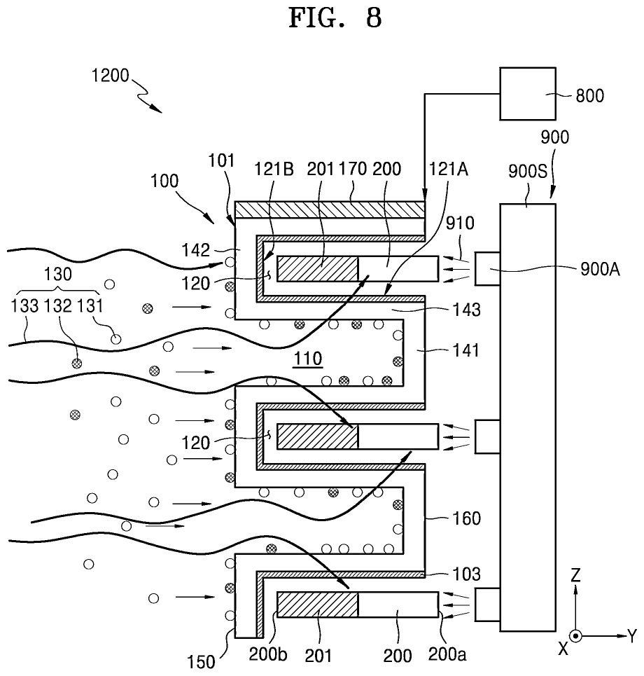

Meanwhile, the filter frame 101 may include a catalytic material activated by different energy from light energy. The filtering system 1100 may be changed as illustrated in FIG. 8 to further supply, according to the catalytic material of the filter frame 101, energy other than light energy. FIG. 8 schematically illustrates a filtering system 1200 including a catalyst filter, according to an embodiment. FIG. 8 illustrates an example in which the filtering system 1200 is provided to further supply energy other than light energy, compared to the filtering system 1000 of FIG. 4, but the disclosure is not limited thereto. The filtering system 1200 may also be provided to further supply energy other than light energy, compared to the filtering system 1100 of FIG. 6.

In this embodiment, a filter frame 101 may include a material that is activated by different energy from light energy to produce a catalytic reaction with respect to a gaseous component included in a material 130. For example, the filter frame 101 may be formed of a catalytic material activated by electrical energy. Here, the catalytic material may include a metal compound capable of an electrically conductive oxygen reduction reaction (“ORR”). The metal compound may be a compound including metal such as Co, Ni, or Mn, or may include precious metal oxide. For example, the filter frame 101 may be formed of a catalytic material activated by thermal energy. Here, the catalytic material may include a metal compound capable of a low-temperature oxidation reaction. The metal compound may be, for example, a compound including Cu, Co, Ni, Fe, Al, Si, or precious metal. The low-temperature oxidation reaction may refer to an oxidation reaction occurring between room temperature and 100° C. The thermal energy may include, for example, infrared energy and may include energy supplied from a heat source such as a heater.

At least a third portion 143 of the filter frame 101 may include a catalytic material activated by energy other than light energy described above. A first portion 141, a second portion 142, and the third portion 143 of the filter frame 101 may all include a catalytic material activated by energy other than the light energy described above. Harmful gas removal performance may be improved by a structure as described above.

When the filter frame 101 includes a catalytic material activated by different energy from light energy, as illustrated in FIG. 8, the filtering system 1200 may be provided to further include an external energy supply source 800. In addition, the filter frame 101 may include an energy receiving unit 170 connected to the external energy supply source 800.

The external energy supply source 800 may supply the filter frame 101 with energy other than light energy. For example, when the filter frame 101 includes a catalytic material activated by electrical energy, the energy receiving unit 170 may be an anode electrode, and the filter frame 101 may function as a cathode electrode. The external energy supply source 800 may supply a current to the filter frame 101 through the energy receiving unit 170. For example, when the filter frame 101 includes a catalytic material activated by thermal energy, the energy receiving unit 170 may be a heating member. The heating member may convert energy supplied from the external energy supply source 800, e.g., electrical energy into thermal energy and supply the thermal energy to the filter frame 101.

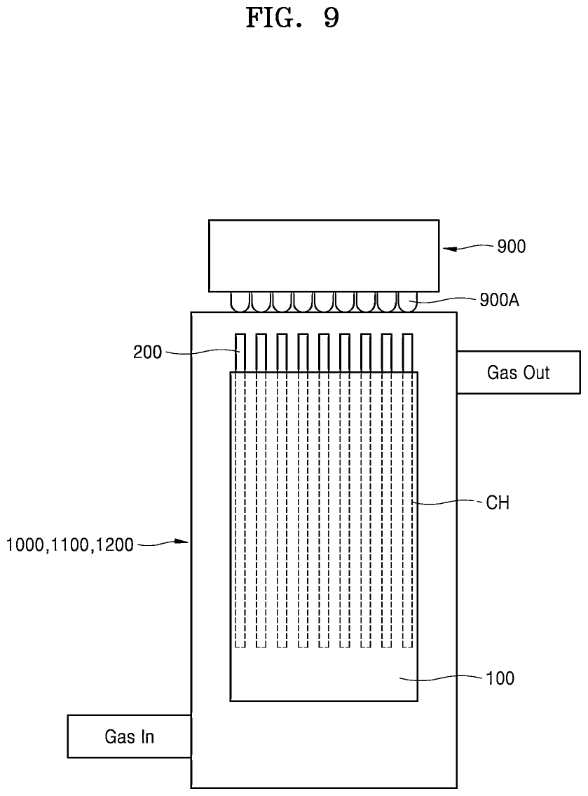

FIG. 9 schematically illustrates a layout of a filtering system 1000, 1100, or 1200 according to various embodiments described above.

Referring to FIG. 9, the filtering system 1000, 1100, or 1200 has an inlet Gas In through which a gas including a material to be purified flows in and an outlet Gas Out through which the filtered gas is discharged, and the waveguide 200 is inserted into each of channels CH of the catalyst filter 100, and the light source unit 900 includes the first light source 900A to correspond to the waveguide 200 of each channel CH. The light source unit 900 may further include the second light source 900B described above.

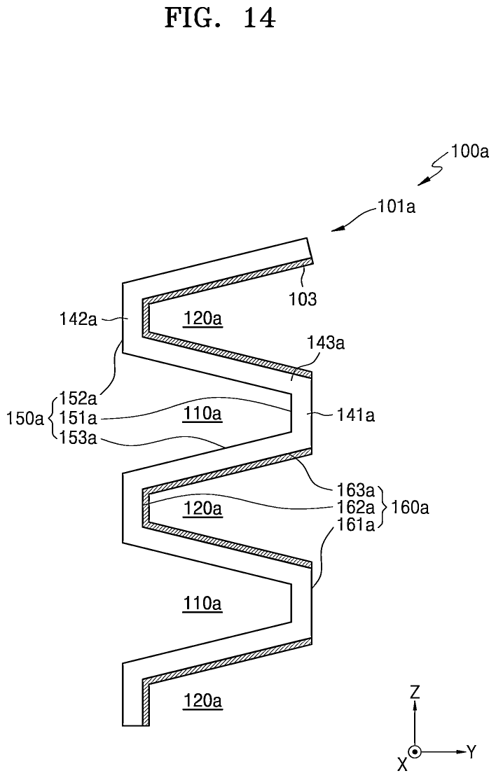

FIG. 10 illustrates an arrangement relationship between a second groove 120 of a filter frame 101 and a waveguide 200 in a filtering system, according to an embodiment. First, as described with reference to the filtering systems 1000, 1100, and 1200 illustrated in FIGS. 4, 6, and 8, in a filtering system according to an embodiment, the waveguide 200 may be applied to increase light transmission into a channel CH of a catalyst filter 100. FIG. 10 may correspond to a portion of the filtering system 1000 illustrated in FIG. 4. FIG. 10 illustrates an example in which the catalyst filter 100 illustrated in FIGS. 1 and 2 is applied, and the same arrangement relationship may be applied to a modification example of the catalyst filter 100 of FIG. 6 and an example in which catalyst filters 100a and 100b illustrated in FIGS. 13 to 15 are applied. The above description may be inferred, and thus, the same illustration and description are omitted.

Referring to FIG. 10, the waveguide 200 may have an incident surface 200a on which light is incident from a corresponding first light source 900A, and may have a rod shape. The waveguide 200 may be arranged to be spaced apart from a bottom 121B of a second groove 120 forming the channel CH, e.g., by a distance D1. At least a partial length D2 of the waveguide 200 may be inserted into the second groove 120 of a filter frame 101. A space may be present between a surface of the waveguide 200 and an end surface 200b of an end portion facing the incident surface 200a, and a photocatalyst layer 103. In addition, the at least partial length D2 of the waveguide 200 may be inserted into the second groove 120 of the filter frame 101, such that the incident surface 200a protrudes from, is drawn into, or is at the same level as a second surface 160 of a first portion 141 of the filter frame 101. A separation distance between the incident surface 200a of the waveguide 200 and the first light source 900A, and a degree to which the waveguide 200 is drawn into or protrudes from the second surface 160 of the filter frame 101, may be determined within a range in which more than an appropriate amount of light emitted from the first light source 900A may be input into the waveguide 200 through the incident surface 200a.

Meanwhile, as illustrated in FIG. 10, the waveguide 200 may include a light extraction region 201 formed in at least a partial region of a portion of the waveguide 200 inserted into the second groove 120 of the filter frame 101 to expand a range (e.g., area) in which light is transmitted inside the channel CH. In other words, the light extraction region 201 may be formed in at least a partial region of a surface of the waveguide 200. The light extraction region 201 may be formed by texturing or roughening the surface of the waveguide 200. For example, the waveguide 200 may be textured or roughened by an etching process using an etching solution to form the light extraction region 201. The etching solution may be determined according to a material forming the waveguide 200. For example, the waveguide 200 may include a quartz rod, glass or quartz-based optical fiber, or the like, and the surface of the waveguide 200 may be textured or roughened by using a buffered oxide etchant (BOE) solution as an etching solution.

The light extraction region 201 may be formed on the entire region, a partial region, or discontinuously on a plurality of points of the waveguide 200. FIGS. 4, 6, 8, and 10 illustrate an example in which the light extraction region 201 is formed on the surface of the waveguide 200 from a location being drawn by a distance D3 from the second surface 160 of the first portion 141 of the filter frame 101, to the end surface 200b of the end portion of the waveguide 200. A range in which the light extraction region 201 is formed and extraction efficiency (a degree of texturing or roughening) may be determined to obtain desired photocatalytic reaction performance from the photocatalyst layer 103 inside the second groove 120.

Light may be directly irradiated from the first light source 900A to an entrance portion of the second groove 120 of the filter frame 101, and thus, the light extraction region 201 of the waveguide 200 may be formed to irradiate light from a location of the second groove 120 at which light is not easy to be directly irradiated to the photocatalyst layer 103. For example, as illustrated in FIG. 10, the light extraction region 201 may be formed from a location being drawn by the distance D3 from the second surface 160 of the first portion 141. FIG. 10 illustrates an example in which the light extraction region 201 is entirely formed on the surface of the waveguide 200, but the disclosure is not limited thereto. For example, as illustrated in FIG. 11, light extraction regions 201 may be discontinuously formed at a plurality of points. As another example, the light extraction region 201 may be entirely formed on the surface of the waveguide 200 or discontinuously at a plurality of points over the entire length of the waveguide 200 from the incident surface 200a to the end surface 200b of the optical waveguide 200.

As well known, the waveguide 200 guides light through internal total reflection on a waveguide surface. The light extraction region 201 enables light, which is input through the incident surface 200a and guided into the waveguide 200, to be extracted as scattered light through the surface of the waveguide 200 corresponding to the waveguide surface.

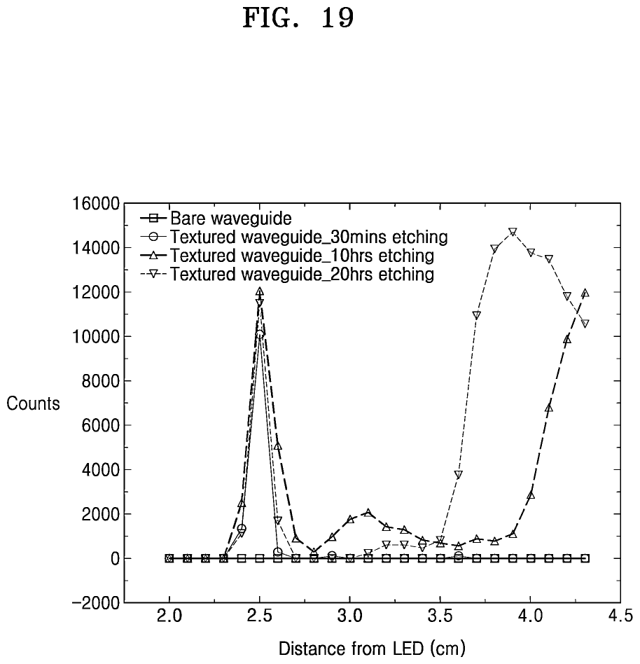

When the waveguide 200 has an overall smooth surface without the light extraction region 201, as shown in an experimental example of FIG. 18 described below, light, which is incident into the waveguide 200 through the incident surface 200a, is mainly emitted, via a guiding process, through the end surface 200b of the end portion of the waveguide 200 facing the incident surface 200a. The light emitted through the end surface 200b of the waveguide 200 is mainly irradiated to a portion of the photocatalyst layer 103 located on a bottom 121B of the second groove 120 of the filter frame 101. In other words, the light is mainly irradiated to a portion of the photocatalyst layer 103 on a second side surface (162 of FIG. 2) of a second portion 142 of the filter frame 101.

In contrast, as in an embodiment, when the waveguide 200 has the light extraction region 201 in at least a partial region of the surface of the waveguide 200, light, which is input into the waveguide 200, is emitted not only through the end surface 200b of the waveguide 200 but also through the light extraction region 201 formed on the surface of the waveguide 200. Therefore, light may be irradiated not only to a portion of the photocatalyst layer 103 located on the bottom 121B of the second groove 120 of the filter frame 101, but also to a portion of the photocatalyst layer 103 located on a side surface 121A.

According to the filtering system according to the embodiment, by introducing the waveguide 200 having the light extraction region 201 formed on at least a portion of the surface of the waveguide 200, light may be irradiate to not only a portion of the photocatalyst layer 103 formed on a second side surface (162 of FIG. 2) of the second portion 142 of the filter frame 101, which is a deep location of a channel, but also to a portion of the photocatalyst layer 103 formed on a second side surface (163 of FIG. 2) of a third portion 143 corresponding to an inner wall of the channel. As described above, light may be irradiated over a wide range of the photocatalyst layer 103 inside the channel, and thus, a region in which a photocatalytic reaction occurs may be expanded.

FIG. 11 illustrates another example of an operation in which light transmission into a channel increases in a filtering system, according to an embodiment.

As illustrated in FIG. 11, a light extraction region 201 may be formed at a plurality of points on a surface of a waveguide 200. At least a portion of a length of the waveguide 200 is inserted into a second groove 120 of a filter frame 101. Light 910 emitted from a first light source 900A is input into the waveguide 200 through an incident surface 200a of the corresponding waveguide 200 and is guided along the waveguide 200. At least some of the guided light may be extracted through the light extraction region 201 and irradiated to a portion of a photocatalyst layer 103 on a second side surface (163 of FIG. 2) of a third portion 143 of the filter frame 101 corresponding to an inner wall of a channel, and some of the light may be output through an end surface 200b of the waveguide 200 and irradiated to a portion of the photocatalyst layer 103 on a second side surface (162 of FIG. 2) of a second portion 142 of the filter frame 101 corresponding to a bottom of the channel. In FIG. 11, reference numeral 915a denotes light that is scattered from the light extraction region 201 and irradiated toward the inner wall of the channel, and reference numeral 915b denotes light that is irradiated toward the bottom of the channel through the end surface 200b of the waveguide 200.

As illustrated in FIGS. 10 and 11, the light extraction region 201 may be formed over a certain range on the surface of the waveguide 200, or the light extraction region 201 may be formed at a plurality of points on the surface of the waveguide 200. Here, the range, locations number, and degree of texturing or roughening of forming the light extraction regions 201 may be variously modified within a range capable of obtaining an intended sufficient photocatalytic reaction.

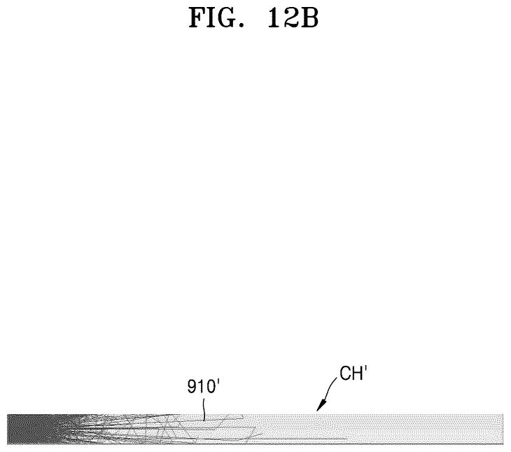

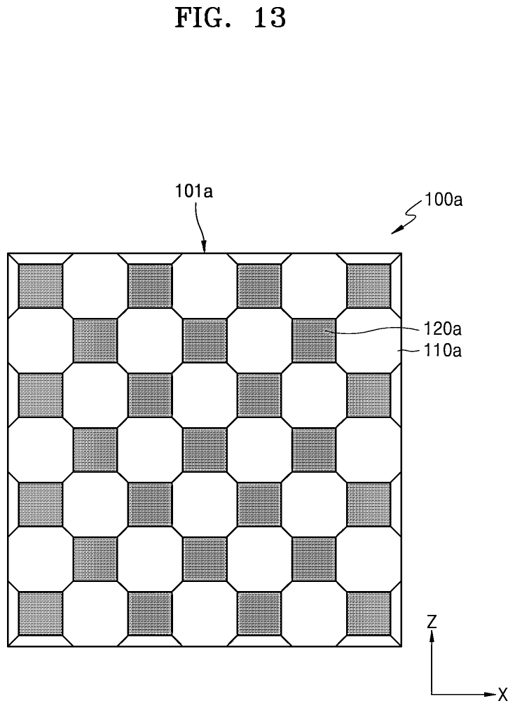

FIG. 12A illustrates an operation of irradiating light to a channel in a filtering system of a comparative example, and FIG. 12B is an image illustrating light transmission inside the channel in the filtering system of the comparative example.

Referring to FIGS. 12A and 12B, the filtering system of the comparative example has a structure in which a waveguide is excluded from a filtering system according to an embodiment. A waveguide is not present, and thus, light 910′ emitted from a light source 900A′ is mainly irradiated only to a portion of a photocatalyst layer 103′ on an entrance side of a second groove 120′ of a filter frame 101′, i.e., a channel CH′, and does not easily reach a deep location of the channel CH′. As described above, in the filtering system of the comparative example, a region in which a photocatalytic reaction of the photocatalyst layer 103′ is produced may be limited.

Meanwhile, in the filtering systems 1000, 1100, and 1200 according to the various embodiments described above, the filter frame 101 of the catalyst filter 100 may include the first groove 110 and the second groove 120 having cross-sectional areas that are or are not uniform. FIGS. 4, 6, and 8 illustrate an example in which, as illustrated in FIGS. 1 and 2, the filtering system 1000, 1100, or 1200 according to an embodiment applies the catalyst filter 100 including the filter frame 101 having the first groove 110 and the second groove 120 having the uniform cross-sectional areas, but the disclosure is not limited thereto. For example, the filtering systems 1000, 1100, and 1200 according to the embodiment may also apply the catalyst filter 100a or 100b including the filter frame 101a or 101b including the first grooves 110a or 110b and the second grooves 120a or 120b having non-uniform cross-sectional areas, illustrated in FIGS. 13 to 15.

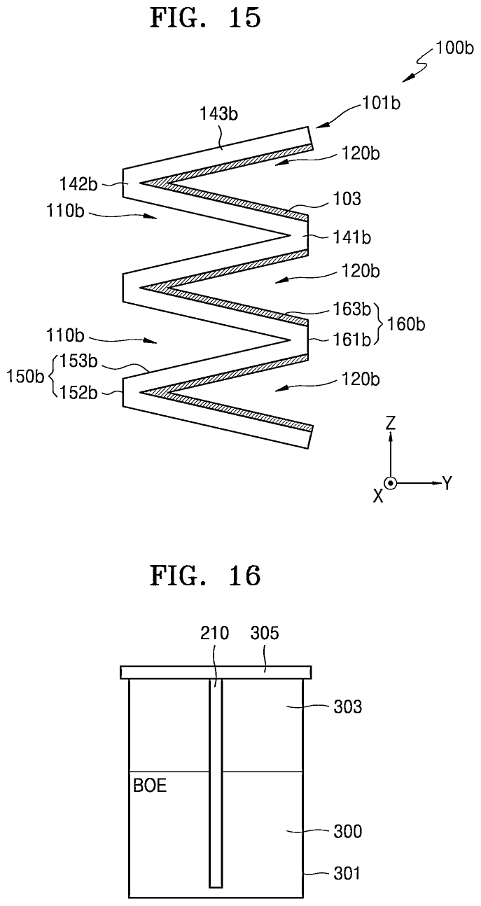

FIG. 13 is a front view of a catalyst filter 100a according to an embodiment, and FIG. 14 is a cross-sectional view of the catalyst filter 100a illustrated in FIG. 13.

Referring to FIGS. 13 and 14, the catalyst filter 100a may include a filter frame 101a and a photocatalyst layer 103. The catalyst filter 100a of the present embodiment is different from the filter frame 101 illustrated in FIGS. 1 and 2 in that the filter frame 101a includes a first groove 110a having a cross-sectional area gradually decreasing in a thickness direction Y and a second groove 120a having a cross-sectional area gradually increasing in the thickness direction Y. The above description of the catalyst filter 100 and the filter frame 101 may be equally applied to the catalyst filter 100a and the filter frame 101a.

The filter frame 101a may include a first portion 141a blocking a second side of the first groove 110a, a second portion 142a blocking a first side of the second groove 120a, and a third portion 143a forming a boundary between the first groove 110a and the second groove 120a. The first portion 141a and the second portion 142a may be spaced apart from each other in the thickness direction Y, and the third portion 143a may slantly extend from an edge of the first portion 141a in a Y direction to be connected to the second portion 142a. First side surfaces 151a, 152a, and 153a of the first portion 141a, the second portion 142a, and the third portion 143a (i.e., the first side surface 151a of the first portion 141a, the first side surface 152a of the second portion 142a, and the first side surface 153a of the third portion 143a together) become a first surface 150a, and second side surfaces 161a, 162a, and 163a of the first portion 141a, the second portion 142a, and the third portion 143a (i.e., the second side surface 161a of the first portion 141a, the second side surface 162a of the second portion 142a, and the second side surface 163a of the third portion 143a together) become a second surface 160a.

A photocatalyst layer 103 may be provided on at least a portion of the second surface 160a of the filter frame 101a. The photocatalyst layer 103 may be formed on the second side surface 163a of at least the third portion 143a of the second surface 160a. The photocatalyst layer 103 may also be formed on the second side surface 162a of the second portion 142a forming a first sidewall of the second groove 120a. The photocatalyst layer 103 may also be formed on the second side surface 161a of the first portion 141a.

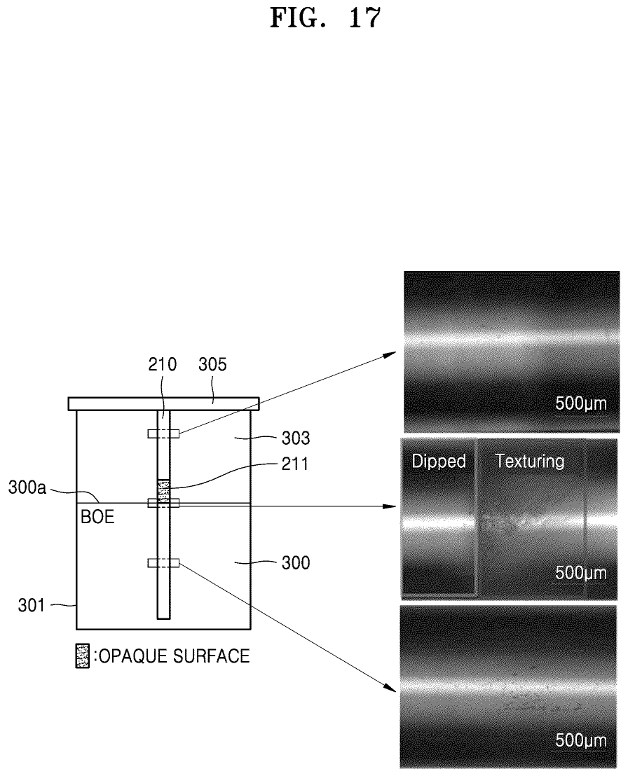

FIG. 15 is a cross-sectional view of a catalyst filter 100b according to an embodiment.

Referring to FIG. 15, the catalyst filter 100b may include a filter frame 101b and a photocatalyst layer 103. The filter frame 101b of the present embodiment is different from the filter frame 101 illustrated in FIGS. 1 and 2 in that the filter frame 101b includes a plurality of first grooves 110b having a wedge shape with a cross-sectional area decreasing in a thickness direction Y, and a plurality of second grooves 120b having a wedge shape with a cross-sectional area decreasing in a direction opposite to the thickness direction Y. The above description of the catalyst filter 100 and the filter frame 101 may be equally applied to the catalyst filter 100b and the filter frame 101b. The filter frame 101b may include a first portion 141b blocking a second side (i.e., outflow side formed by the second side surfaces 161 and the outlets of the second grooves 120) of the first groove 110b, a second portion 142b blocking a first side (i.e., inflow side formed by the first side surfaces 152 and the inlets of the first grooves 110) of the second groove 120b, and a third portion 143b forming a boundary between the first groove 110b and the second groove 120b. The first groove 110b and the second groove 120b have the wedge shapes, and thus, a first side surface of the first portion 141b and a second side surface of the second portion 142b are not formed. Therefore, first side surfaces 152b and 153b of the second portion 142b and the third portion 143b become a first surface 150b, and second side surfaces 161a and 163a of the first portion 141b and the third portion 143b become a second surface 160b. The photocatalyst layer 103 may be provided on at least a portion of the second surface 160b of the filter frame 101b. The photocatalyst layer 103 may be formed on the second side surface 163b of at least the third portion 143b of the second surface 160b. The photocatalyst layer 103 may be further formed on the second side surface 161b of the first portion 141b of the second surface 160b.

Meanwhile, as described above, the photocatalyst layer 103 is formed on at least some of the second surfaces 160, 160a, and 160b of the filter frames 101, 101a, and 101b of the catalyst filters 100, 100a, and 100b, but is not limited thereto.

For example, the filter frames 101, 101a, and 101b may be formed to include photocatalyst materials, and the photocatalyst layer 103 may correspond to a thickness activated by light energy of the filter frames 101, 101a, and 101b. When the filter frames 101, 101a, 101b are formed to include photocatalyst materials, the filter frames 101, 101a, and 101b may be formed of the photocatalyst materials, or may be formed of materials in which porous ceramic materials and photocatalyst materials are mixed. In addition, the filter frames 101, 101a, and 101b may further include catalyst materials activated by energy other than light energy. The photocatalytic materials of the filter frames 101, 101a, and 101b may include metal compounds that may receive light energy and produce photocatalytic reactions. The metal compound may be, for example, a photocatalyst material having semiconductor characteristics by light, such as TiO₂ or WO₃. The light energy may be ultraviolet energy or visible light energy. An oxidation/reduction action of the photocatalytic material is as described above with reference to FIG. 3, and thus, a description thereof is omitted herein.

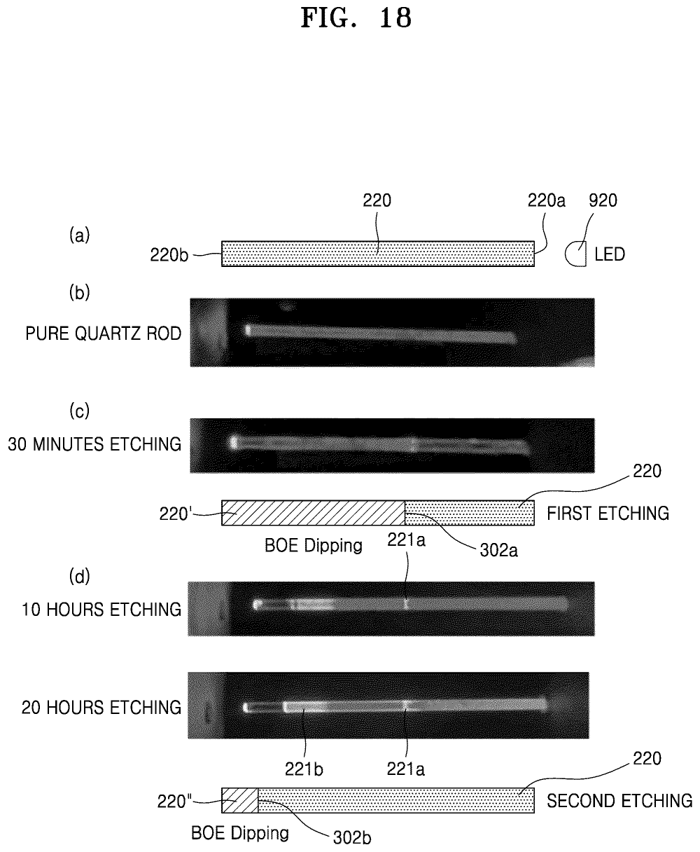

Hereinafter, an example of a method of forming the light extraction region 201 of the waveguide 200 to expand a range of light transmission into a channel in the filtering system according to an embodiment is described with reference to FIGS. 16 to 18. As described below, the light extraction region 201 of the waveguide 200 may be formed by, for example, texturing a surface of a quartz rod by vapor of an etching solution.

FIGS. 16 and 17 illustrate a process of forming a light extraction region by texturing a surface of a waveguide, FIG. 16 illustrates a preparation state before texturing, and FIG. 17 illustrates a textured state. FIG. 16 illustrates that a waveguide 210 is a bare waveguide before forming a light extraction region.

As illustrated in FIG. 16, the bare waveguide 210, e.g., a quartz rod, is prepared for texturing by vapor of an etching solution 300. A container 301 is filled with the etching solution 300 to a certain height such that a partial length of the waveguide 210 is dipped into the etching solution 300. The container 301 is sealed by a lid 305 while the partial length of the waveguide 210 is dipped into the etching solution 300. A space 303, which is not filled with the etching solution 300, is present in the container 301. FIG. 16 illustrates that the waveguide 210 is fixed to the lid 305, but the disclosure is not limited thereto. A separate structure may be used to fix the waveguide 210.

The etching solution 300 may be determined according to a material forming the waveguide 210. When a quartz rod or a glass or quartz-based optical fiber is used as the waveguide 210, the etching solution 300 may be, for example, a BOE solution. The BOE solution may be, for example, a solution including NH₄F+HF.

As described above, when the container 301 is sealed and a certain period of time elapses while the partial length of the waveguide 210 is dipped into the etching solution 300, as illustrated in FIG. 17, a surface of the waveguide 210 is etched and textured by etching solution vapor evaporating from an etching solution surface 300a into a space 303, e.g., BOE vapor. As described above, when texturing is performed by using vapor of the etching solution 300, as illustrated in a photo on the right side of FIG. 17, a portion of the waveguide 210 close to the etching solution surface 300a is formed as a textured surface, and the portion forms a light extraction region 211. A location far from the etching solution surface 300a or a portion dipped into the etching solution 300 is not textured. As illustrated in the left drawing of FIG. 17, an opaque surface represents a portion textured by vapor of the etching solution 300, and corresponds to a light extraction region 211. As illustrated in the photo on the right side of FIG. 17, when light is irradiated onto the surface of the waveguide 210, a non-uniform pattern is formed on the textured portion to scatter the irradiated light, and thus, the textured portion has a poor light transmittance, and the portion dipped into the etching solution 300 or other portions have a high light transmittance due to the surface of waveguide 210 that is not textured.

A size of the light extraction region 211 may increase or the light extraction region 211 may be formed at a plurality of points by repeating a texturing process a plurality of times for a certain period of time while changing a level of the etching solution 300 included in the container 301 or changing a length of the waveguide 210 dipped into the etching solution 300.

FIG. 18 illustrates an example of a change in light extraction efficiency according to a condition for forming a light extraction region on a surface of a quartz rod 220 (a waveguide). As illustrated in (a) of FIG. 18, the quartz rod 220 and a light source (LED) 920 are arranged such that light emitted from the light source (LED) 920 is incident on an incident surface 220a, to confirm light extraction efficiency. As illustrated in (b) of FIG. 18, a pure quartz rod does not include a light extraction region on a surface of the quartz rod 220, and thus, light is emitted only through an end surface 220b of an end portion facing the incident surface 220a. In (c) of FIG. 18, an example in which first etching is performed for 30 minutes when about half a length of the quartz rod 220 is dipped into a BOE solution is shown. In (c) of FIG. 18, reference numeral 220′ denotes a quartz rod portion dipped into a BOE solution during first etching, and reference numeral 302a denotes a level location of the BOE solution. A first portion 221a of the quartz rod 220 close to a BOE solution surface 302a is etched and textured by vapor during first etching to form a light extraction region, and thus, light is emitted not only through the end surface 220b of the end portion of the quartz rod 220 but also through the first portion 221a that is textured during the first etching. FIG. 18 (d) illustrates the result of performing second etching for 10 hours and 20 hours when a shorter length of the quartz rod 220 than during the first etching is dipped into the BOE solution. Reference numeral 220″ denotes a quartz rod portion dipped into the BOE solution during the second etching, and reference numeral 302b denotes the level location of the BOE solution during the second etching.

Referring to (d) of FIG. 18, a second portion 221b of the quartz rod 220 close to a BOE solution surface 302b is textured by vapor of the BOE solution during the second etching. Here, the second portion 221b of the quartz rod 220 is a portion dipped into the BOE solution during the first etching, and thus is formed over a wider range than the first portion 221a formed during the first etching, and is formed to exhibit higher light extraction efficiency. In addition, even when the first portion 221a of the quartz rod 220 during the second etching is located at a considerable distance from the BOE solution surface 301a during the second etching, light extraction efficiency of the first portion 221a increases compared to the first etching.

As illustrated in (c) and (d) of FIG. 18, brightness of the first portion 221a and the second portion 221b indicates the degree of light extraction efficiency. The first portion 221a and the second portion 221b correspond to light extraction regions, respectively, and as inferred from (d) of FIG. 18, the first portion 221a and the second portion 221b may be formed to be spaced apart from each other or connected to each other by adjusting the degree to which the quartz rod 220 is dipped into the BOE solution. As described above, the light extraction region may be entirely formed on at least a portion of the surface of the quartz rod 220 or may be formed at a plurality of points.

Meanwhile, as illustrated in FIG. 18, when an etching process is performed again while a length dipped into a BOE solution is reduced to expose at least a portion of a portion dipped into the BOE solution during a previous etching process, a surface of a quartz rod is textured to a location further away from a BOE solution surface, and etching is performed in a direction in which light extraction efficiency also increases.

Therefore, when texturing is repeated a plurality of times by vapor of an etching solution while changing a height to which the waveguide 200 is dipped into the etching solution to form the light extraction region 201 of the waveguide 200 according to an embodiment, a texturing process may be performed to expose, in a subsequent etching process, at least a portion of a portion dipped into the etching solution. By the texturing method described above, a range of the light extraction region 201 formed on the surface of the waveguide 200 may be expanded, and light extraction efficiency may also increase.

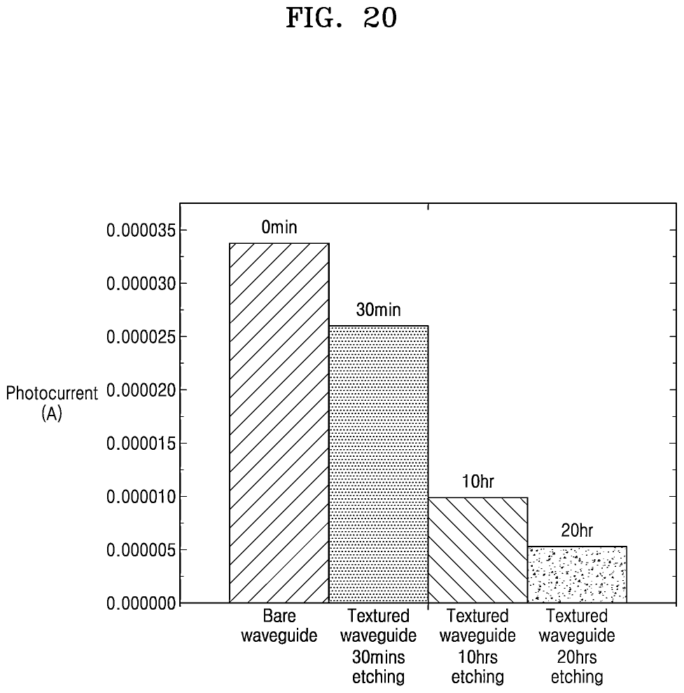

FIGS. 19 and 20 illustrate results of measuring a photocurrent at a side surface and a lower end of the waveguide 200 according to an etching time. In FIG. 19, a horizontal axis denotes a distance from a light source (an LED) to the incident surface 200a of the waveguide 200, and a vertical axis denotes the number of photons measured by a photoelectric current measurement device.

As illustrated in FIG. 19, when an etching time increases, the number of photons emitted from a side surface (a surface) of the waveguide 200 increases. As illustrated in FIG. 20, when the etching time increases, the photoelectric current decreases at a lower end (an end surface) of the waveguide 200. In other words, an intensity of light emitted to the lower end is relatively weakened due to an increase of light scattering on the side surface of the waveguide 200, and thus, light may be effectively irradiated when the waveguide 200 having the light extraction region 201 formed on the surface thereof is inserted into a channel of the catalyst filter 100, e.g., to a photocatalyst coated on an inner wall of the channel.

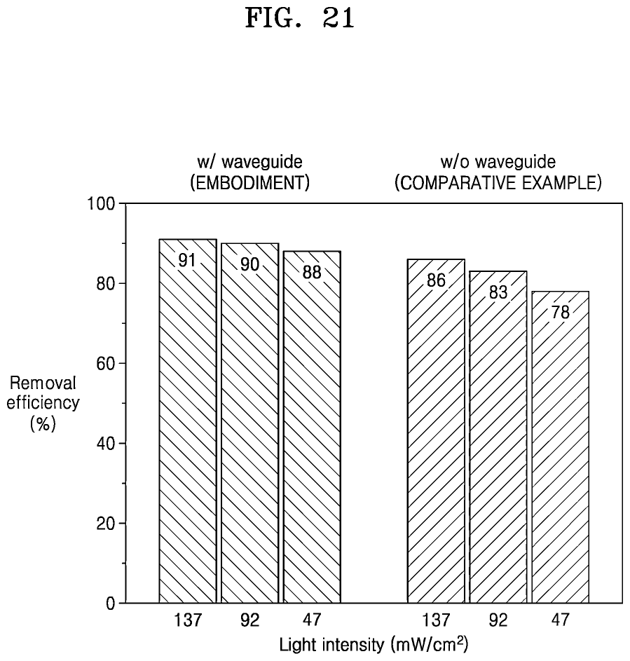

FIG. 21 illustrates formaldehyde (“HCHO”) removal efficiency of a filtering system, according to an embodiment. For comparison, FIG. 21 illustrates efficiency of removing formaldehyde (HCHO) when the waveguide 200 is inserted into a channel of a catalyst filter (with waveguide: an embodiment) and efficiency of removing formaldehyde (HCHO) when the waveguide 200 is not inserted into the channel of the catalyst filter (without waveguide: a comparative example). An experiment of the embodiment confirms the efficiency of removing formaldehyde (HCHO) by installing the waveguide 200 on the channel of the catalyst filter and using an 80 channel UV-LED module. An experiment of the comparative example is carried out under the same condition as the experiment of the embodiment, except that a waveguide is not present.

As illustrated in FIG. 21, when a waveguide is inserted into a channel of a catalyst filter, formaldehyde removal efficiency is improved by about 5% to about 10% compared to the comparative example in which a waveguide is not present. In addition, when an amount of light irradiated is low, efficiency of light transmission into the channel of the catalyst filter is lowered, and thus, photocatalytic activity is lowered. However, when the waveguide is inserted, the formaldehyde removal efficiency is high (improved to from 78% to 88%) even in a low amount of light. In addition, when using an optical waveguide, a decrease in formaldehyde removal efficiency compared to a decrease in the amount of light irradiated is also lower than in the comparative example in which the waveguide is not present.

As described above, according to a filtering system according to an embodiment, light transmission into a channel may increase by inserting, into the channel of a catalyst filter, a waveguide having a light extraction region on a surface thereof. Therefore, light may be effectively irradiated over a wide range of a photocatalyst inside the channel, and thus, efficiency of removing a VOC or harmful gas passing through a filter frame by a photocatalytic reaction may be improved.

According to a filtering system including a catalyst filter according to an embodiment, light may be irradiated over a wide range of a photocatalyst layer inside a channel by inserting a waveguide into the channel of a catalyst filter to effectively transmit light into the channel, and thus, a region in which a photocatalytic reaction occurs may be expanded, and removal efficiency of a gaseous material may be improved.

A filtering system including a catalyst filter described above and a method of forming a light extraction region of a waveguide have been described with reference to the embodiments shown in the drawing, but the description is only illustrative, and those skilled in the art will understand that various modifications and equivalent other embodiments may be made therefrom. It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A filtering system comprising:
a catalyst filter including a filter frame including a first surface, which includes a first side surface in a thickness direction, and a second surface, which includes a second side surface opposite to the first side surface in the thickness direction and forms a plurality of channels, wherein the catalyst filter further includes a photocatalyst layer arranged on the second surface of the filter frame and configured to be activated by light energy;
a light source unit configured to irradiate light for activating the photocatalyst layer; and
a plurality of waveguides inserted into at least some of the plurality of channels, respectively, to increase light transmission into the at least some of the plurality of channels.

2. The filtering system of claim 1, wherein each waveguide of the plurality of the waveguides
has an incident surface on which light is incident from the light source unit,
has a rod shape, and
has a light extraction region formed on at least a portion of a surface of each waveguide to extract light that is input through the incident surface and guided into each waveguide such that a range in which light is transmitted into a corresponding channel of the at least some of the plurality of channels is expanded.

3. The filtering system of claim 2, wherein the light extraction region of each waveguide is formed by texturing the surface of each waveguide by vapor of an etching solution.

4. The filtering system of claim 3, wherein the light extraction region of each waveguide is formed by texturing each waveguide a plurality of times by vapor of the etching solution while reducing a length of each waveguide dipped into the etching solution.

5. The filtering system of claim 3, wherein each waveguide is a quartz rod, and
the etching solution is a buffered oxide etchant (BOE) solution.

6. The filtering system of claim 1, wherein the filter frame includes a catalyst material configured to be activated by energy other than light to remove a gaseous material, or includes a photocatalytic material configured to be activated by light energy.

7. The filtering system of claim 1, wherein the photocatalyst layer
includes a metal compound having semiconductor characteristics by light, and the metal compound includes at least one of titanium dioxide (TiO₂) and tungsten trioxide (WO₃).

8. The filtering system of claim 1, wherein the light source unit
includes a plurality of first light sources corresponding to the plurality of channels on a one-to-one basis, and
each waveguide of the plurality of the waveguides receives light incident from a corresponding first light source of the plurality of first light sources.

9. The filtering system of claim 8, wherein the filter frame includes:
a plurality of first grooves extending in the thickness direction and including inflow sides opened and outflow sides blocked; and
a plurality of second grooves extending in the thickness direction, and including outflow sides opened and inflow sides blocked,
wherein the plurality of first grooves and the plurality of second grooves are alternately and two-dimensionally arranged, and
the second grooves form the plurality of channels.

10. The filtering system of claim 9, wherein each waveguide is arranged to be spaced apart from the inflow side of a corresponding second groove of the plurality of second grooves.

11. The filtering system of claim 9, wherein the filter frame includes a first portion configured to block the outflow sides of the first grooves, a second portion configured to block the inflow sides of the second grooves, and a third portion configured to form a boundary between the first grooves and the second grooves, and
the photocatalyst layer is provided on the second surface of at least one of the second portion and the third portion of the filter frame.

12. The filtering system of claim 11, wherein the photocatalyst layer is further provided on the second surface of the first portion of the filter frame, and
the light source unit further includes a plurality of second light sources configured to irradiate light to at least some of regions of the second surface between the plurality of channels.

13. The filtering system of claim 12, wherein the first light source and the second light source include light emitting diodes (LEDs).

14. The filtering system of claim 8, wherein the first light source includes an LED.

15. A filtering system comprising:
a catalyst filter including a filter frame including a first surface, which includes a first side surface in a thickness direction, and a second surface, which includes a second side surface opposite to the first side surface in the thickness direction and forms a plurality of channels, wherein the catalyst filter further includes a photocatalyst layer arranged on the second surface of the filter frame and configured to be activated by light energy;
a light source unit configured to irradiate light for activating the photocatalyst layer; and
a plurality of waveguides inserted into at least some of the plurality of channels, respectively, to increase light transmission into the at least some of the plurality of channels, wherein
the filter frame includes:
a plurality of first grooves extending in the thickness direction, and including inflow sides opened and outflow sides blocked; and a plurality of second grooves extending in the thickness direction, and including outflow sides opened and inflow sides blocked, wherein the plurality of first grooves and the plurality of second grooves are alternately and two-dimensionally arranged, the second grooves form the channels, and
each waveguide of the plurality of waveguides
has an incident surface on which light is incident from the light source unit, has a rod shape, and has a light extraction region formed on at least a portion of a surface of each waveguide to extract light that is input through the incident surface and guided into each waveguide such that a range in which light is transmitted into a corresponding channel of the at least some of the plurality of channels is expanded.

16. The filtering system of claim 15, wherein the filter frame includes a first portion configured to block the outflow sides of the first grooves, a second portion configured to block the inflow sides of the second grooves, and a third portion configured to form a boundary between the first grooves and the second grooves, and
the photocatalyst layer is provided on the second surface of at least one of the second portion and the third portion of the filter frame.

17. The filtering system of claim 16, wherein the photocatalyst layer is further provided on the second surface of the first portion of the filter frame.

18. The filtering system of claim 15, wherein the photocatalyst layer
includes a metal compound having semiconductor characteristics by light, and the metal compound includes at least one of TiO₂ and WO₃.

19. A method of forming a light extraction region of a waveguide including:
forming a light extraction region on a surface of a waveguide by dipping a partial length of the waveguide having an incident surface and having a rod shape into an etching solution and texturing the surface of the waveguide by vapor of the etching solution; and
repeating the texturing process a plurality of times by the vapor of the etching solution while reducing by changing the length of the waveguide dipped into the etching solution.

20. The method of claim 19, wherein the waveguide is a quartz rod, and the etching solution is a BOE solution.
